(19) United States
(12) Patent Application Publication
(10) Pub. No.: US 2007/0142227 A1
(43) Pub. Date: Jun. 21, 2007

(54) Systemic inducer composition for plants

(76) Inventor: A. Harry J. Rajamannan, Minneapolis, MN (US)

Correspondence Address: Herman H. Bains, 6101 Tracy Ave, Minneapolis, MN, 55436, US

(21) Appl. No.: 11/297,178

(22) Filed: Dec. 9, 2005

Related U.S. Application Data
(63) Continuation-in-part of application No. 10/448,828, filed on May 30, 2003, now abandoned.
(63) Continuation-in-part of application No. 10/448,831, filed on May 30, 2003, now abandoned.
(63) Continuation-in-part of application No. 10/448,830, filed on May 30, 2003, now abandoned.
(63) Continuation-in-part of application No. 10/448,829, filed on May 30, 2003, now abandoned.

(51) Int. Cl. A01N 63/00

(52) U.S. Cl. 504/117

(57) ABSTRACT

A systemic inducer comprising a chemical compound combined with microorganismic substance extracted from non-plant pathogenic microorganisms. The compound includes an acid and/or the salt of phosphorus, potassium, calcium, sodium, magnesium, manganese, zinc, copper and iron. The microorganismic substance may be extracted from fungus, bacteria or virus. The systemic inducer may be applied to stems, leaves, seeds, flowers or fruits of plants. Alternatively, the systemic inducer may be applied to soil to elicit a response via the roots of the plants. Finally, the systemic inducer may be injected into the stem or pseudo stem of the plants. The inducer effectively enables the induced plants to resist attack by pathogens to plants, seedlings, leaves, fruits, flowers and roots.

Fungicides, bactericides and insecticides have been applied since the 1950's to control fungi, bacteria, insects and nematodes that attack the plants. These chemical pesticides are not only contaminating the environment, pose a danger to workers, leave traces of pesticides in the co produce consumed, but is also becoming quite useless as these pathogens are fast developing resistance to these chemical agents.

Compounds such as, phosphates, phosphites potassium, calcium, magnesium, manganese, zinc, copper, iron and sodium have been used as fertilizers for several decades in many forms.

These compounds to be effective as plant nutrients have to be applied in quantities as small as 25 pounds to as high as 200 pounds per acre.

When these compounds are applied for their nutrient value, they never impart any pesticidal effect to the plants to which the compounds are applied. They never impart any effect on the plant to enable the plant to resist infections by fungus, virus and bacterial pathogens or enable the plant to resist attack by insects. If these compounds were able to impart this special effect, there would not be any need for pesticides in producing a crop.

### SUMMARY OF THE INVENTION

An object of this invention is to provide a systemic inducer for plants made up of certain chemical compounds combined with either live or dead microorganisms or extracts of these microorganisms obtained by macerating them physically, chemically or enzymatically and which when applied to the plants with the purpose of inducing resistance within the plants to foliar and root pathogens and to a variety of insects including nematodes.

In the embodiment disclosed, the compounds used are phosphoric acids, phosphorous acids, phosphates, phosphites, salts of calcium, magnesium, potassium, manganese, zinc, copper, iron and sodium, in amounts per acre insufficient to have any nutrient value. Microorganismic substances alive or in an extracted or hydrolyzed form is combined with the above compounds and applied to plants to provide this systemic resistance to plant diseases and infestations by insects.

The systemic inducer may be applied to the stem, leaves, flowers or fruits of plants. Alternatively, the systemic inducer may be applied to soil to elicit induction into the plants via the roots of plants.

### DESCRIPTION OF THE PREFERRED EMBODIMENT

Plants have the ability to ward off infections by fungal, bacteria, virus and insects to a certain degree. Some varieties have natural resistance built in to ward off severe infections. These varieties have been either selected by genetists to offer to the agricultural industry a variety of plants that do not need a pesticide to resist a particular pathogen. In this selection process the plants selected rarely have the ability to ward off more than one pathogen and definitely do not ward off say a fungal infection and simultaneously an insect infestation.

The plants' inherent ability to develop this extra resistance is called “systemic acquired resistance”. Any material that is applied to plants for plants to develop such extra resistance is called “inducers”. So applying certain inducers can elicit certain plants to develop systemic resistance. This is a new field of investigation and development.

The closest parallel process is akin to a human developing resistance to a particular disease after being vaccinated. Compounds such as phosphites, phosphates, oxalates and salicylates are known to provide a very small degree of immunity to plants, but not enough for plants to produce a crop without the use of pesticides such as insecticides, fungicides and nematacides.

We have developed products comprising organisms or extracts of these microorganisms when combined with phosphoric acids, phosphorous acids, phosphates, phosphites, salts of calcium, magnesium, potassium, manganese, zinc, copper, iron and sodium and applied to plants can induce these plants to develop extra resistance naturally to ward off fungal, bacterial, viral and insect infections at the same time such that no pesticides need to be applied to produce a crop. This program will eventually lead to producing fruits, vegetables and cereals without the use of any pesticides. This would be a boom to the world and consumers.

The present invention provides a systemic resistance inducer that is obtained by phosphorous acid and salts thereof, phosphoric acid and salts thereof and the salts of calcium, magnesium, potassium, zinc, manganese, copper, iron and sodium combined with extracts of microorganisms. The systemic inducer is applied to plants as a foliar application, or applied to the soil on which the plants are planted. These microorganismic extracts do not by themselves cause any induction or invade the plant if used alone, as they are selected from organisms that do not cause any disease to plants by themselves, so the 100% effective induction that is taking place only if and when these extracts are used in combination with the compounds listed above. Growth enhancers or regulators such as betaine, benzothiodiazole, jasmonic acid, cytokinins, auxins and gibberellins, beta amino butyric acid, may be added to the combination to improve plants productivity. These compounds by themselves used in the amounts in this invention, do not have any nutritional effect or induction effect.

### EXAMPLE 1

Non plant pathogenic microorganisms were grown in a growth medium and allowed to die by attenuating it with formaldehyde or exposing to microwaves or hydrolyzed with acids and the total extracts obtained from these organisms were tested for induction of resistance on various plants such as strawberry, apple, tomato and banana. These plants thus treated were then challenged by exposing the plants to pathogens such as downey, mildew, phytopthora, black sigatoka and thrips and mites. The plants suffered severe infestation. But when these same extracts were combined with a phosphate or phosphite salt or calcium nitrate and applied to similar set of plants in the same manner of the application of extracts alone, all plants resisted the infestation of fungal and insects. When these chemical compounds were used alone without the microorganismic extracts they did not induce any resistance (See Table I) for the results.

### EXAMPLE 2

The microorganisms such as from a pseudomonads species, bacillus subtilis, rhodotorulum species, xanthomonas species were specifically cultured together, hydrolyzed and the extracts used either alone or in combination with a calcium phosphite, potassium phosphate, calcium citrate on a set of plants. Such plants included lettuce, strawberry, tomato, grapes, banana, blueberry, apples, corn and potatoes.
1. The microorganismic compounds applied alone is shown on Table II. A.
2. The micro-organismic compound used in combination with chemical compound such as calcium phosphite etc. are shown in Table II. B.
3. The chemical compounds used by themselves is shown in Table II. C.

The combination of the compound and the microorganismic were made two weeks prior to the window and during the period of heavy natural infestations on the plants listed above except bananas, with no pesticides applied. In banana foliar applications were sprayed weekly for six (6) months with no fungicides applied. In banana a control set of plants were sprayed weekly with conventional systemic and protectant fungicides.

When the insect infestation time arrived, the insect traps that were placed in the blocks where the combined product was used to treat showed zero infestation by insects, such as thrips, mites, Japanese beetle, leaf hopper and blueberry maggot fly while the non-combined product used showed the usual heavy infestation.

There was no scab in the apple, potatoes had no signs of infection by rhyzoctonia, no infestations of phytophera on tomato, and citrus were recorded. There was no leaf fungal infection on the leaves on potato, strawberry, citrus, tomato and low sigatoka infection occurred in bananas. There were no insects to be found in the traps or on the leaves. There were no nematode infestation in banana, tomato and strawberry roots.

When these same microorganismic compounds were applied by themselves to plants that were exposed to the various pathogens little if any resistance was found to be induced. When the chemical compounds were applied alone, zero resistance to the infestation was also recorded.

### EXAMPLE 3

These chemical compounds were tested at rates 0.25 to 3 kg per acre of citrus, strawberries, tomatoes and bananas by themselves to measure (A) fertilizer effect on foliar uptake, (B) growth effect, (C) resistance induction effect. These compounds were then combined with extracts of pseudomonas, subtilis species and actinomyces and applied to the similar set of plants and measured for A, B, and C as above. These extracts were also applied to a similar set of plants and measured for A, B, and C as above.

The results are shown in Table III where the compounds showed zero effect of induction alone but excellent induction when combined with the microorganismic extracts, and the fertilizer effect at these low rates showed very little increase in foliar analysis for the elements content and no extra growth effect.

TABLE I
A
Effect of Compounds Applied to Strawberry Plant to Induce Restance

| | | | | | | Results in | |
|---|---|---|---|---|---|---|---|
| Chemical | | Micro-Organic | | When | Where | Foliar | Results in Root |
| Compound | Dose | Extract | Dose | Applied | Applied | Infections | Infection |
| potassium phosphate | 1.5 kg per acre | microbial ground extract | 5 grams per acre | once a week | foliar | zero infection | zero nematode infestation |
| ″ | — | ″ | 5 grams per acre | ″ | ″ | 25% infection | 20% nematode infection |
| ″ | 1.5 kg per acre | ″ | — | ″ | ″ | 20% infection | 20% nematode infection |
| calcium phosphite | 1.5 kg per acre | ″ | 5 grams per acre | ″ | ″ | zero infection | zero nematode infestation |
| ″ | — | ″ | 5 grams per acre | ″ | ″ | 25% infection | 20% nematode infection |
| ″ | 1.5 kg per acre | ″ | — | ″ | ″ | 15% infection | 20% nematode infection |
| calcium nitrate | 1.5 kg per acre | ″ | 5 grams per acre | ″ | ″ | zero infection | zero nematode infestation |
| ″ | — | ″ | 5 grams per acre | ″ | ″ | 25% infection | 20% nematode infection |
| ″ | 1.5 kg per acre | ″ | — | ″ | ″ | 20% infection | 20% nematode infection |

B
Effect of Compounds Applied to Apple Trees to Induce Restance Against Fire Blight

| | | | | | | Results On |
|---|---|---|---|---|---|---|
| | | | | | Where | Development |
| Chemical Compound | Dose | Micro-Organic Extract | Dose | When Applied | Applied | of Fire Blight |
| potassium phosphate | 1.5 kg per acre | microbial ground extract | 5 grams per acre | twice 10 day intervals after bud break | foliar | 2% fire blight |
| ″ | — | ″ | 5 grams per acre | ″ | ″ | 20% fire blight |
| ″ | 1.5 kg per acre | ″ | — | ″ | ″ | 18% fire blight |
| calcium phosphite | 1.5 kg per acre | ″ | 5 grams per acre | ″ | ″ | zero fire blight |
| ″ | — | ″ | 5 grams per acre | ″ | ″ | 20% fire blight |
| ″ | 1.5 kg per acre | ″ | — | ″ | ″ | 15% fire blight |
| calcium nitrate | 1.5 kg per acre | ″ | 5 grams per acre | ″ | ″ | 2% fire blight |
| ″ | — | ″ | 5 grams per acre | ″ | ″ | 20% fire blight |
| ″ | 1.5 kg per acre | ″ | — | ″ | ″ | 20% fire blight |

C
Effect of Compounds Applied to Tomato Plants to Induce Restance Against Leaf & Root Infection

| | | Micro- | | | | |
|---|---|---|---|---|---|---|
| Chemical | | Organic | | | Where | |
| Compound | Dose | Extract | Dose | When Applied | Applied | Results In Foliar & Root Infections |
| potassium phosphate | 1.5 kg per acre | extract | 5 grams per acre | every 10 days | foliar | zero foliar, zero phytopthora, zero nematodes |
| ″ | — | ″ | 5 grams per acre | ″ | ″ | 20% foliar infection, 15% phytopthora, 20% nematode |
| ″ | 1.5 kg per acre | ″ | ″ | ″ | ″ | 15% foliar infection, 15% phytopthora, 20% nematrode |
| calcium phosphite | 1.5 kg per acre | ″ | 5 grams per acre | ″ | ″ | zero foliar infection, zero phytopthora, zero nematodes |
| ″ | — | ″ | 5 grams per acre | ″ | ″ | 20% foliar infection, 15% phytopthora, 20% nematode |
| ″ | 1.5 kg per acre | ″ | ″ | ″ | ″ | 12% foliar infection, 15% phytopthora, 20% nematode |
| calcium nitrate | 1.5 kg per acre | ″ | 5 grams per acre | ″ | ″ | zero foliar, zero phytopthora, zero nematodes |
| ″ | — | ″ | 5 grams per acre | ″ | ″ | 20% foliar infection, 15% phytopthora, 20% nematode |
| ″ | 1.5 kg per acre | ″ | ″ | ″ | ″ | 15% foliar infection, 15% phytopthora, 20% nematrode |

D
Effect of Compounds Applied to Bananas to Induce Resistance Against Black Sigatoka & Nematodes

| Chemical | | Micro-Organic | | When | Where | |
|---|---|---|---|---|---|---|
| Compound | Dose | Extract | Dose | Applied | Applied | Results On Black Sigatoka Nematode Infection |
| Potassium | 1.5 Kg Per Acre | Extract | 5 grams per acre | Every Week | Foliar | 12 Leaves at Flowering, Zero Nematode infection |
| Phosphate | | | | | | |
| | | ″ | 5 grams per acre | ″ | ″ | 6 Leaves at Flowering, High Nematode infection |
| Potassium | 1.5 Kg Per Acre | ″ | | ″ | ″ | 7 Leaves at Flowering, High Nematode infection |
| Phosphate | | | | | | |
| Calcium Phosphite | 1.5 Kg Per Acre | ″ | 5 grams per acre | ″ | ″ | 13 Leaves at Flowering, Zero Nematode infection |
| ″ | — | ″ | 5 grams per acre | ″ | ″ | 6 Leaves at Flowering, High Nematode infection |
| ″ | 1.5 Kg Per Acre | ″ | — | ″ | ″ | 8 Leaves at Flowering, High Nematode infection |
| Calcium Nitrate | 1.5 Kg Per Acre | ″ | 5 grams per acre | ″ | ″ | 12 Leaves at Flowering, Zero Nematode infection |
| ″ | — | ″ | 5 grams per acre | ″ | ″ | 6 Leaves at Flowering, High Nematode infection |
| ″ | 1.5 Kg Per Acre | ″ | — | ″ | ″ | 7 Leaves at Flowering, High Nematode infection |

TABLE II
A Extract Applied Alone
Effect of Specific Microrganism Extracts & Chemical Compounds in Resistance Inducing

| Chemical | | | | | Where | |
|---|---|---|---|---|---|---|
| Compound | Dose | Extract | Dose | Appilcation Timing | Applied | Results On Black Sigatoka Nematode Infection |
| — | — | extract eg II | 5 grams | lettuce every 10 days | foliar | 40% infection of leaves |
| — | — | ″ | 5 grams | strawberry every 10 days | foliar | 20% infected leaves & 10% infected fruits |
| — | — | ″ | 5 grams | tomatoes every week | foliar | 40% infected leaves |
| — | — | ″ | 5 grams | grapes every 15 days | foliar | 25% mildew |
| — | — | ″ | 5 grams | bananas every week for 6 months | foliar | 3 leaves without sigatoka infection high |
| — | — | ″ | 5 grams | blueberries every 15 days | foliar | 15% infected fruits, 5% fruits infected by |
| | | | | | | nematode in roots |
| — | — | ″ | 5 grams | apples (2 yrs old) 10 days post bud | foliar | 25% leaves fire blight burn |
| | | | | break & 1 week later | | blueberry maggots |
| — | — | ″ | 5 grams | potatoes 4 times during season | foliar | 25% leaves infected with early bligjht |

TABLE II B
Chemical & Extracts Applied Together
Effect of Specific Microrganism Extracts & Chemical Compounds in Resistance Inducing

| Chemical Compound | Dose | Extract | Dose | Application Timing | Where Applied | Results |
|---|---|---|---|---|---|---|
| calcium phosphite | 25 grams | extract eg II | 5 grams | latuce every 10 days | foliar | 2% infection of leaves |
| potassium phosphite | 25 grams | ″ | 5 grams | ″ | ″ | 5% infection of leaves |
| calcium citrate | 25 grams | ″ | 5 grams | ″ | ″ | 1% infection of leaves |
| calcium phosphite | 25 grams | ″ | 5 grams | strawberries every 10 days | ″ | 5% infected leaves |
| potassium phosphite | 25 grams | ″ | 5 grams | ″ | ″ | 4% infected leaves |
| calcium citrate | 25 grams | ″ | 5 grams | ″ | ″ | 2% infected leaves |
| calcium phosphite | 25 grams | ″ | 5 grams | tomatoes every week | ″ | 6% leaf infection |
| potassium phosphite | 25 grams | ″ | 5 grams | ″ | ″ | 5% leaf infection |
| calcium citrate | 25 grams | ″ | 5 grams | ″ | ″ | 3% leaf infection |
| calcium phosphite | 25 grams | extract from eg II | 5 grams | grapes every 15 days | foliar | 2% mildew |
| potassium phosphite | 25 grams | ″ | 5 grams | ″ | ″ | 4% mildew |
| calcium citrate | 25 grams | ″ | 5 grams | ″ | ″ | 1% mildew |
| calcium phosphite | 25 grams | ″ | 5 grams | bananas every week | ″ | 7 leaves without infection, |
| | | | | for 6 months | | zero nematodes in roots |
| potassium phosphite | 25 grams | ″ | 5 grams | bananas every week | ″ | 7 leaves without sigatoka infection, |
| | | | | for 6 months | | zero nematodes in roots |
| calcium citrate | 25 grams | ″ | 5 grams | bananas every week | ″ | 6 leaves without sigatoka infection, |
| | | | | for 6 months | | zero nematodes in roots |
| calcium phosphite | 25 grams | extract from eg II | 5 grams | blueberry every 15 days | foliar | 2% infection of fruits, |
| | | | | | | zero maggot flies in fruits |
| potassium phosphite | 25 grams | ″ | 5 grams | ″ | ″ | 3% infection of fruits, |
| | | | | | | zero maggot flies in fruits |
| calcium citrate | 25 grams | ″ | 5 grams | ″ | ″ | 2% infection of fruits, |
| | | | | | | zero maggot flies in fruits |
| calcium phosphite | 25 grams | ″ | 5 grams | Apples (2 yr old) 10 days post | foliar | 2% fire blight burn |
| | | | | bud break & 1 week later | | |
| potassium phosphite | 25 grams | ″ | 5 grams | Apples (2 yr old) 10 days post | ″ | 3% fire blight burn |
| | | | | bud break & 1 week later | | |
| calcium citrate | 25 grams | ″ | 5 grams | Apples (2 yr old) 10 days post | ″ | 2% fire blight burn |
| | | | | bud break & 1 week later | | |
| calcium phosphite | 25 grams | extract eg II | 5 grams | Potatoes 4 times during | foliar | less than 5% infected leaves |
| | | | | season for early & late blight | | |
| potassium phosphite | 25 grams | ″ | 5 grams | Potatoes 4 times during | ″ | less than 7% infected leaves |
| | | | | season for early & late blight | | |
| calcium citrate | 25 grams | ″ | 5 grams | Potatoes 4 times during | ″ | less than 2% infected leaves |
| | | | | season for early & late blight | | |

TABLE II C
Chemical Compound Applied Alone
Effect of Specific Microrganism Extracts & Chemical Compounds in Resistance Inducing

| Chemical Compound | Dose | Extract | Dose | Application Timing | Where Applied | Results |
|---|---|---|---|---|---|---|
| calcium phosphite | 25 grams | — | — | blueberry every 15 days | foliar | 30% infection of fruits |
| potassium phosphite | 25 grams | — | — | ″ | ″ | 35% infection of fruits |
| calcium citrate | 25 grams | — | — | ″ | ″ | 30% infection of fruits |
| calcium phosphite | 25 grams | — | — | apples (2 yr old) 10 days post bud | foliar | 25% fire blight burn |
| | | | | break & 1 week later | | |
| potassium phosphite | 25 grams | — | — | apples (2 yr old) 10 days post bud | ″ | 25% fire blight burn |
| | | | | break & 1 week later | | |
| calcium citrate | 25 grams | — | — | apples (2 yr old) 10 days post bud | ″ | 20% fire blight burn |
| | | | | break & 1 week later | | |
| calcium phosphite | 25 grams | — | — | potetoes 4 times during season | foliar | 30% leaf infected with early & late blight |
| | | | | for early & late blight | | |
| potassium phosphite | 25 grams | — | — | potetoes 4 times during season | ″ | 35% leaf infection |
| | | | | for early & late blight | | |
| calcium citrate | 25 grams | — | — | potetoes 4 times during season | ″ | 25% leaf infection |
| | | | | for early & late blight | | |
| calcium phosphite | 25 grams | — | — | lettuce every 10 days | foliar | 90% infection |
| potassium phosphite | 25 grams | — | — | ″ | ″ | 85% infection |
| calcium citrate | 25 grams | — | — | ″ | ″ | 90% infection |
| calcium phosphite | 25 grams | — | — | strawberry every 10 days | foliar | 90% infection |
| potassium phosphite | 25 grams | — | — | ″ | ″ | 85% infection |
| calcium citrate | 25 grams | — | — | ″ | ″ | 80% infection |
| calcium phosphite | 25 grams | — | — | tomatoes every week | foliar | 90% infection |
| potassium phosphite | 25 grams | — | — | ″ | ″ | 100% infection |
| calcium citrate | 25 grams | — | — | ″ | ″ | 85% infection |
| calcium phosphite | 25 grams | — | — | grapes every 15 days | foliar | 60% mildew |
| potassium phosphite | 25 grams | — | — | ″ | ″ | 70% mildew |
| calcium citrate | 25 grams | — | — | ″ | ″ | 55% mildew |
| calcium phosphite | 25 grams | — | — | bananas every week for 6 months | foliar | 80% infection-all leaves except youngest 3 |
| potassium phosphite | 25 grams | — | — | ″ | ″ | 90% infection-all leaves except youngest 4 |
| calcium citrate | 25 grams | — | — | ″ | ″ | 85% infection-all leaves except youngest 3 |
| | | | | | | High infection of nematodes in roots |
| | | | | | | in all 3 experiments |

TABLE III
Effects of Different Amounts of Chemical Compounds for Nutrient & Induction Effects
Compounds & Extracts Applied Together

| Chemical | | | | | Results-Foliar | | |
|---|---|---|---|---|---|---|---|
| Compound | Dose | Microrganisms | Dose | Application Timing | Analysis | Growth effect | Induction of Resistance |
| calcium | 3 kg | extract from | 5 grams | foliar, | zero increase | very little | die back reversed, new flush |
| phosphite | | example 2 | | 4 times in 1 year, citrus | in leaf CA or P | | phytopthora in roots very low, 10% |
| potassium | 3 kg | extract from | 5 grams | foliar, | zero increase | very little | die back reversed, new flush |
| phosphite | | example 2 | | 4 times in 1 year, citrus | in leaf CA or P | | phytopthora in roots very low, 10% |
| calcium | 3 kg | extract from | 5 grams | every 10 days in | zero increase | very little | good control of |
| phosphite | | example 2 | | strawberry | in leaf CA or P | | leaf disease, 5% infection |
| potassium | 3 kg | extract from | 5 grams | every 10 days in | zero increase | very little | excellent leaf disease control |
| phosphite | | example 2 | | strawberry | in leaf K or P | | 2% infected leaves |
| calcium | 3 kg | extract from | 5 grams | every 10 days, | zero increase | very little | 5% leaf infection |
| phosphite | | example 3 | | tomatoes | in CA or P | | zero phytopthora in roots |
| potassium | 3 kg | extract from | 5 grams | every 10 days, | zero increase | very little | 3% leaf infection |
| phosphite | | example 3 | | tomatoes | in foliar CA or P | | zero phytopthora in roots |
| calcium | 3 kg | extract from | 5 grams | every week, foliar | zero increase in | very little | Sigatoka control, 7 leaves with |
| phosphite | | example 3 | | for 6 months, bananas | CA or P in leaves | | no symptoms zero nematodes in roots |
| potassium | 3 kg | extract from | 5 grams | every week, foliar | zero increase in | very little | Sigatoka control, 7 leaves with |
| phosphite | | example 3 | | for 6 months, bananas | CA or P in leaves | | no symptoms zero nematodes in roots |

Compounds Applied Alone

| | | Microrganism | | | | | |
|---|---|---|---|---|---|---|---|
| Chemical | | from | | | | | |
| Compound | Dose | example 3 | Dose | Application Timing | Results-Foliar Analysis | Growth effect | Induction of Resistance |
| calcium | 3 kg | | — | 4 times in one year, | no increase in | zero improvement | zero resistance to phytopthora, |
| phosphite | | | | citrus | leaf CA or P | in production | die back as usual |
| potassium | 3 kg | | — | 4 times in one year, | no improvement in | zero improvement | zero resistance to phytopthora, |
| phosphite | | | | citrus | foliar K or P | in production | die back as usual |
| calcium | 3 kg | — | — | every 10 days, | no improvement in foliar | no increase in | no visible foliar disease |
| phosphite | | | | strawberry | uptake of CA or P | production | suppression, 30% infection |
| potassium | 3 kg | — | — | every 10 days, | no improvement in foliar | no increase in | no visible foliar disease |
| phosphite | | | | strawberry | uptake of CA or P | production | suppression, 25% infection |
| calcium | 3 kg | — | — | every 10 days, foliar, | .001% increase in CA & | no increase in | leaf disease, botrylis zero control, |
| phosphite | | | | tomatoes | zero increase in P | production | phytopthora zero control, |
| | | | | | | | 30% leaf infection |
| potassium | 3 kg | — | — | every 10 days, foliar, | no increase in K or P | no increase in | leaf disease, botrylis zero control, |
| phosphite | | | | tomatoes | | production | phytopthora zero control, |
| | | | | | | | 35% leaf infection |
| calcium | 3 kg | — | — | every week, foliar, | no increase in foliar | no increase in | Black Sigatoka Infection high, |
| phosphite | | | | bananas for 6 months | analysis of CA or P | production | nematode infection very high. |
| potassium | 3 kg | — | — | every week, foliar, | no increase in foliar | no increase in | only 4 youngest leaves |
| phosphite | | | | bananas for 6 months | analysis of CA or P | production | without symptoms |

Extracts Applied Alone

| Micro-organisms | | Application | | | |
|---|---|---|---|---|---|
| from Ex. 3 | Dose | Timing | Results-Foliar Analysis | Growth effect | Induction of Resistance |
| extract from example 3 | 5 grams | 4 times a year, | zero increase in foliar CA or P | zero increase in any growth | dio back bad, roots heavily |
| | | foliar, citrus | | | infected with phytopthora |
| extract from example 3 | 5 grams | every 10 days, | zero increase in foliar CA or P | zero increase in any growth | high foliar fungal disease 30% |
| | | foliar, strawberry | | | |
| extract from example 3 | 5 grams | every 10 days, | zero increase in foliar CA or P | zero increase in any growth | 50% leaves infected, roots |
| | | foliar, tomatoes | | | infected with phytopthora |
| extract from example 3 | 5 grams | every week, | zero increase in foliar CA or P | zero increase in any growth | 3 leaves without symptoms, roots |
| | | foliar, bananas | | | have 75% infection with nematodes |

What is claimed is:

1. A systemic inducer composition for plants. Comprising a chemical compound selected from the group consisting acids or salts selected from the group consisting of phosphorus, potassium, calcium, sodium, magnesium, manganese, zinc, copper and iron in amounts of at least 25 grams per acre of plants combined with a microorganismic substance selected from the group consisting of a ground up extract from dead microorganisms or live microorganism in amounts of at lease 5 grams per acre of plants for application to plants for inducing resistance to infestation by insects, fungus, bacteria and virus.

2. A method of providing a systemic inducer to plants comprising, combining a compound selected from the group consisting of phosphoric acid and phosphorous acid and the salts thereof, and the salts of a metal selected from the group consisting of phosphorus, potassium, calcium, sodium, magnesium, manganese, zinc, copper, and iron, with a microorganismic substance selected from the group consisting of an extract from bacteria, an extract from viruses, an extract from fungi, live bacteria and live fungi, and applying the systemic inducer to plants for inducing resistance to the plants to infestation by insects, fungi, bacteria and viruses.

3. A systemic inducer as defined in claim 1 wherein the phosphorous acid is selected from phosphorous acid, hypophosphorous acid, polyphosphorous acid, polyhypophosphorous acid and the salts thereof.

4. The systemic inducer as defined in claim 1 wherein the microorganism is hydrolyzed chemically to extract the proteins and peptides therefrom.

5. The systemic inducer as defined in claim 1 wherein the microorganism is ground up sufficiently to extract nucleotides therefrom including deoxyribonucleotides and ribonucleotides.

6. The systemic inducer as defined in claim 1, wherein the microorganism is grown and allowed to die a natural death and the residues were the extracts.

7. The systemic inducer as defined in claim 1 including betaine, cytokinin, ISO-nicotinic acid, benzothiadizole, beta-amino-butyric acid, gibberellins, auxin and jasmonic acid.

8. The method as defined in claim 2 wherein the systemic inducer is sprayed on the young fruit of a banana plant or plantano plant before the flower bunch of the plant is bagged for protection from insects and chemical or environmentally caused speckling.

9. The method as defined in claim 2 wherein the systemic inducer is applied to the stems, leaves, flowers or fruits of the plants.

10. The method as defined in claim 2 wherein the systemic inducer is applied to the soil where plants are growing to elicit a response in the plants via the roots of the plants.

11. The method as defined in claim 2 where the systemic inducers is applied to seeds prior to planting to allow the young seedling to develop resistance.

12. The method as defined in claim 2 wherein the systemic inducer is injected into the stems or pseudo stems of the plants.

13. The systemic inducer composition as defined in claim 2 wherein the compound is phosphoric acid or the salts thereof.

14. The systemic inducer composition as defined in claim 2 wherein the compound is phosphorous acid or the salts thereof.

15. The systemic inducer composition as defined in claim 2 wherein the compound is a salt selected from the group consisting of phosphorus, potassium, calcium, sodium, magnesium, manganese, zinc, copper and iron.

16. The systemic inducer composition as defined in claim 2 where the inducer is applied to the plant to induce resistance to the roots against nematode attacks and root pathogen attacks.

17. The systemic inducer composition as defined in claim 2 where the inducer when applied to the plant prevents attack on the leaves. Fruits and the leaves by fungal, bacterial pathogens and insects.
